(19) United States
(12) Patent Application Publication
(10) Pub. No.: US 2016/0050146 A1
(43) Pub. Date: Feb. 18, 2016

(54) ACCELERATED STORAGE APPLIANCE USING A NETWORK SWITCH

(71) Applicant: TURBOSTER, INC., Santa Clara, CA (US)

(72) Inventor: Alex Henderson, San Carlos, CA (US)

(73) Assignee: TURBOSTOR, INC., Santa Clara, CA (US)

(21) Appl. No.: 14/827,160

(22) Filed: Aug. 14, 2015

Related U.S. Application Data
(60) Provisional application No. 62/038,136, filed on Aug. 15, 2014.

(51) Int. Cl. H04L 12/741; H04L 29/12; H04L 29/08

(52) U.S. Cl. CPC H04L 45/745; H04L 67/1097; H04L 61/103

(57) ABSTRACT

A storage appliance includes: control circuitry; a plurality of storage communication ports; and switch circuitry configured to forward packets compliant with a storage protocol to identified ones of the plurality of storage communication ports. In an aspect, a memory supports a forwarding table or tables. The apparatus can implement storage appliance operations by division of the storage appliance operations into (i) data movement operations performed by the switch circuitry instead of the general processor circuitry and (ii) general computation operations performed by the switch circuitry instead of the general processor circuitry. The control circuitry supports a plurality of packet fields of packets compliant with the storage protocol, the plurality of packet fields including at least a first packet field of the storage protocol for at least one of a data link layer address and a network layer address that identifies one of the plurality of storage communication ports via one of the plurality of forwarding tables in the memory, and a second packet field of the storage protocol identifying said one of the plurality of forwarding tables.

### REFERENCE TO RELATED APPLICATION

This application claims the benefit of U.S. Provisional Patent Application No. 62/038,136 filed 15 Aug. 2014 entitled Accelerated Storage Appliance Using A Network Switch. This application is incorporated by reference herein.

### BACKGROUND OF THE INVENTION

1. Field of the Invention

The present technology pertains to methods and apparatuses with storage appliances using network switches. Most storage appliances have been built using embedded computer systems. Similar systems can be implemented using a closely coupled combination of network switching elements and embedded computer systems. In one embodiment of this invention, an Ethernet switching component is used to perform data movement functions conventionally performed by the embedded computer systems.

State of the art computer data center storage technology is based upon distributed systems comprising a number of storage appliances 100 based on high performance computer systems 102 as shown in FIG. 1A. The computer system 102 is frequently a commodity server comprising a motherboard with a general processor, power supplies, memory, storage devices 101 and network interfaces 103. Multiple ones these storage appliances 100 are connected to external network switches 104 to form a “cluster” as shown in FIG. 1B. The network switch 104 in a cluster typically provides Ethernet, Infiniband or Fibre Channel connectivity between the storage appliances 100 in the cluster and storage clients (storage devices). Unlike the network switch 104, the storage appliance 100 terminates or originates traffic with storage devices 101 coupled to the ports.

### SUMMARY

These appliance features when implemented in a computer system are computation intensive so current implementations use high performance computer systems. Throughput is limited by these resources. This limitation is the result of treating storage applications as a compute task.

Storage appliance features can be divided in to data movement operations and compute operations. State of the art embedded computer systems are capable of multi gigabit throughput while state of the art network switches are capable of multi terabit throughput. Thus implementing the data movement component of these features with network switches results in a higher performance and less compute intensive implementation of these features. Some embodiments include a switch with a powerful data movement engine but limited capability for decision making (such as if/then/else) and packet modification (such as editing). These features tend to be limited to using a field in a packet to perform a lookup in a table (destination address) and take some limited actions based on the result—like removing or adding a header like an MPLS label or VLAN tag or sending copies of a packet to multiple places. However, the switch lacks general purpose programmability, for example to run a program like a database on a switch.

The present technology provides methods and apparatuses for these implementations reducing the compute resources required for storage appliance features. The methods and apparatuses described in this patent use the higher performance available from the network switching components—despite the limited general computing ability—to accelerate the performance of conventional storage appliances for features such as virtualization, data protection, snapshots, de-duplication and object storage.

A storage appliance includes: control circuitry configured to support a plurality of storage commands of the storage protocol including at least a write storage command that writes to the plurality of storage devices and a read storage command that reads from the plurality of storage devices; a plurality of storage communication ports coupleable to different ones of a plurality of storage devices; and switch circuitry configured to forward, at at least one of a data link layer and a network layer, packets compliant with a storage protocol, to identified ones of the plurality of storage communication ports. In an aspect, a memory supports a forwarding table, the forwarding table associating at least one of a data link layer address and a network layer address to one of a plurality of storage communication ports. The apparatus can implement storage appliance operations by division of the storage appliance operations into (i) data movement operations performed by the switch circuitry instead of the general processor circuitry and (ii) general computation operations performed by the switch circuitry instead of the general processor circuitry. In another aspect, a memory can support a plurality of forwarding tables, different ones of the plurality of forwarding tables associating at least one of a same data link layer address and a same network layer address to different ones of the plurality of storage communication ports. The control circuitry supports a plurality of packet fields of packets compliant with the storage protocol, the plurality of packet fields including at least a first packet field of the storage protocol for at least one of a data link layer address and a network layer address that identifies one of the plurality of storage communication ports via one of the plurality of forwarding tables in the memory, and a second packet field of the storage protocol identifying said one of the plurality of forwarding tables.

Various embodiments are directed to the data link layer address, or the network layer address.

In various embodiments the storage appliance operations include: storage virtualization, data protection, parity de-clustered RAID, thin provisioning, de-duplication, snapshots, and/or object storage.

In one embodiment the write storage command and the read storage command identify a storage block number.

### BRIEF DESCRIPTION OF THE DRAWINGS

FIG. 1A: A Storage Appliance and a Cluster of Storage Appliances

FIG. 1B: A Cluster of Storage Appliances

FIG. 2: Storage Virtualization

FIG. 3: A RAID5 Data Layout

FIG. 4: Parity De-clustered RAID Data Layouts

FIG. 5: Thin Provisioning

FIG. 6: Simplified De-duplication

FIG. 7: Copy on Write and Redirect on Write Snapshots

FIG. 8: Clones Implemented as Multiple Snapshots

FIG. 9: Snapshots of Clones

FIG. 10: An Object Store

FIG. 11A: Serial Replication in Object Stores

FIG. 11B: Splay Replication in Object Stores

FIG. 12: Ring Representation of a Hash Space

FIG. 13A: Layer2 Forwarding

FIG. 13B: Alternative Layer2 Forwarding

FIGS. 14A and 14B: Switch Based Storage Appliance

FIG. 15: Clustering Switch Based Storage Appliances

FIG. 16: Simple Storage Protocol

FIG. 17: Switch Based Virtualization, SSP Example

FIG. 18: RAID0 or Striping

FIG. 19: Write for SCSI Derived Protocols

FIG. 20: Read for SCSI Derived Protocols

FIG. 21: RAID1 or Mirroring

FIG. 22: RAID5 or Parity RAID

FIG. 23: Virtualized RAID5

FIG. 24: A Parity Tree

FIG. 25: A Master and Snapshots

FIG. 26: Redirecting Reads

FIG. 27: Multicast Reads

FIG. 28: Resolving the Results of Multicast Reads

FIG. 29: Distributed Application and Storage Appliance

FIGS. 30A and 30B: Alternate Forwarding Method for Distributed Applications

### DETAILED DESCRIPTION

Overview

The present technology provides methods and apparatuses for using the higher performance available from the network switching components to accelerate the performance of conventional storage appliances for storage features such as virtualization, data protection snapshots, de-duplication and object storage.

The term read command refers to a command that retrieves stored data from a storage address such as a block number, but does not modify the stored data. The term write command refers to a command that modifies stored data including operations such as a SCSI atomic test and set. Unlike higher layer abstraction commands such as HTTP GET or POST that can work with variable sized documents in a hierarchical namespace (e.g., http command: get/turbostor/firstdraft.doc), the storage command can work with numbered blocks of data (e.g., read block 1234).

The network switch can be a Fibre Channel switch, Ethernet switch or layer3 switch. The switch memory can contain multiple virtual forwarding tables. Some of the fields in the storage protocols e.g. some of the bits from the logical block address and relative offset fields, select between virtual forwarding tables that contain the same MAC address with different port associations to send packets to different storage targets based on the lba (Logical Block Address) and relative offset. The technology can be implemented in multiple ways, such as:

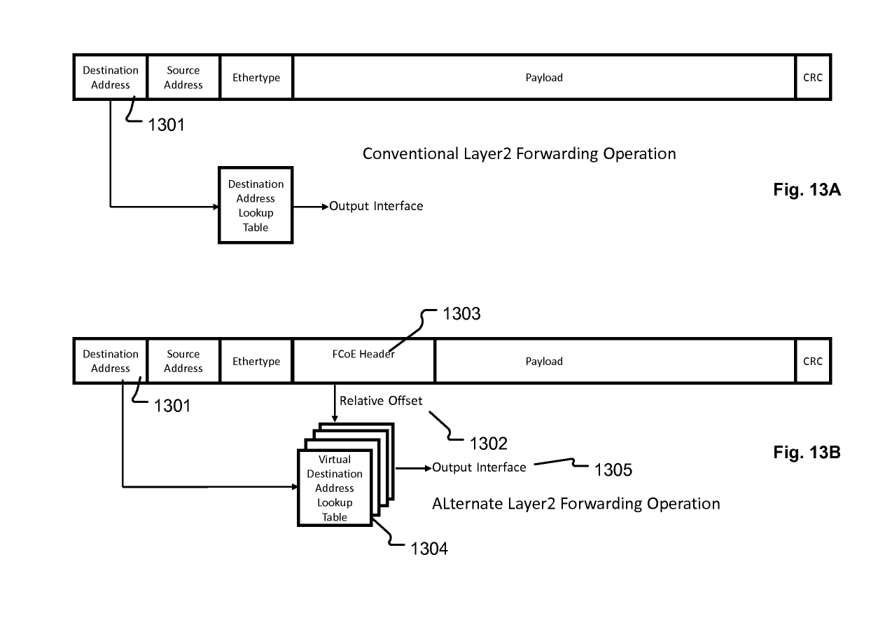

1. Switches, such as the Broadcom XGS Ethernet switches, are capable of making configurable forwarding decisions and multicasting packets based on fields in the packets not conventionally used for packet forwarding, and can be used advantageously as described in the following paragraphs. FIG. 13A illustrates conventional forwarding using an Ethernet Destination Address (DA) 1301. The protocol fields used in this case will include a field that identifies the storage target being accessed and upper layer storage protocol fields identifying which location on a storage target a client is reading or writing. In one embodiment MAC addresses identify storage targets and the relative offset fields 1302 in the FCoE storage protocol identify the locations accessed. This forwarding mechanism is illustrated in FIG. l3B. In this method the relative offset field 1302 from a FCoE header 1303 is used to select from a plurality of virtual destination address tables 1304 used to determine which output interface the packet 1305 is forwarded to.

2. Storage client software can be modified to place the fields used to identify storage targets and locations being accessed in fields used by fixed function switches to make forwarding decisions. For example the accessed Logical Block Address (LBA) is used by modified client software or hardware to determine which device in a RAID set a block is located on, and a VLAN field is added to a storage packet such that the switch forwards the packet to the correct target device.

These techniques are used to redirect and replicate storage packets such that a switch can be used to perform the data movement component of a variety of storage features as described in the following embodiments of this technology.

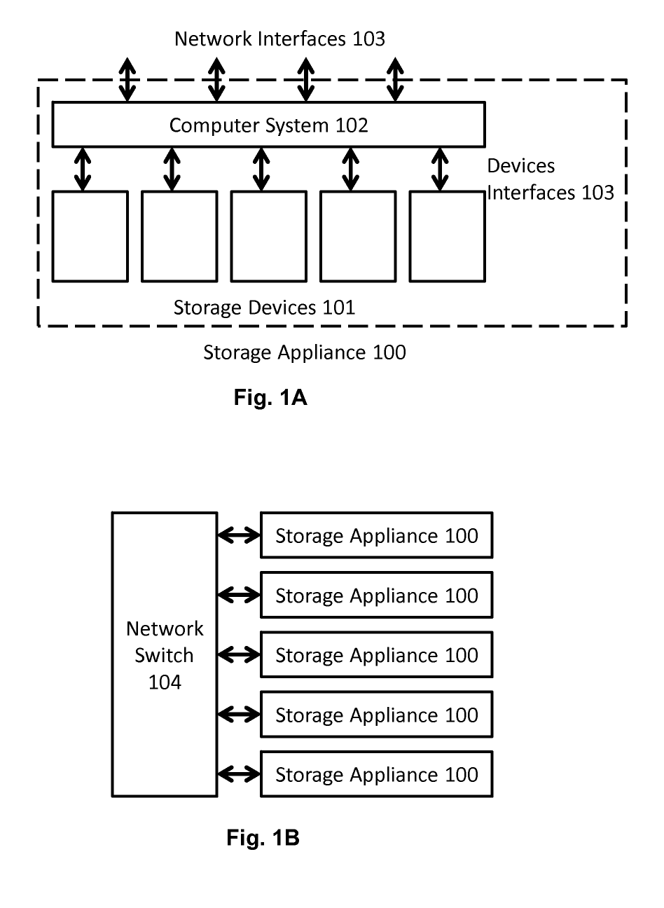

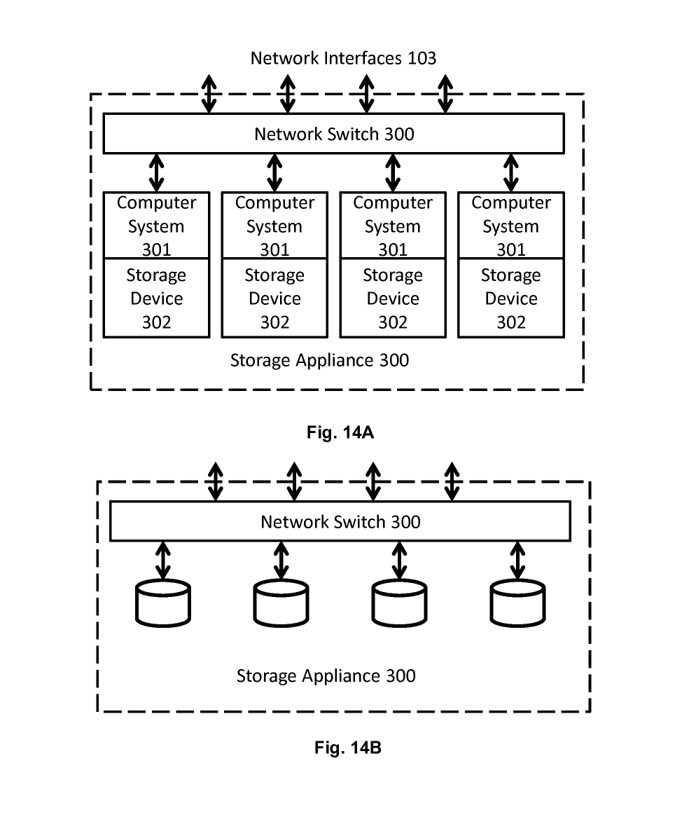

FIG. 14A is a block diagram of a storage appliance 300 where the computer system 102 of FIG. 1 is replaced with a network switch 300 and a number of smaller computer systems 301. Each computer system 301 has one or more storage devices 302 attached to it. The simplified block diagram FIG. 14B represents the same appliance. The storage modules comprise the computer and storage device(s) of FIG. 14A. Example modules include a general processor, memory, network interfaces/ports, and nonvolatile storage.

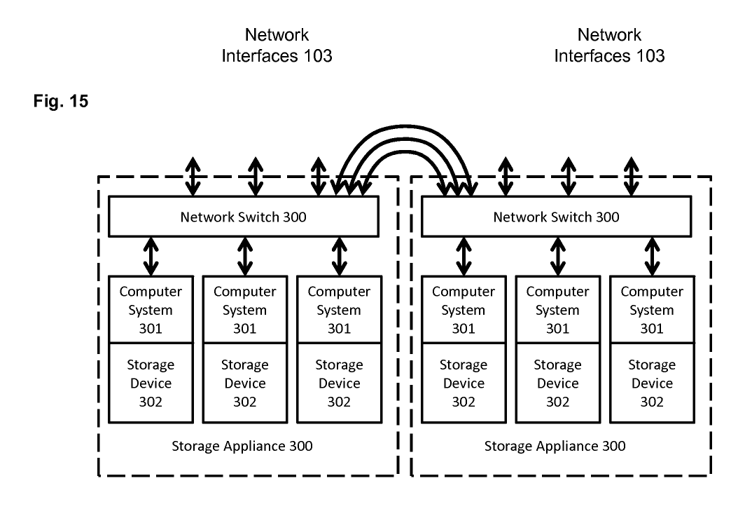

FIG. 15 illustrates one advantage of this implementation. Multiple such storage appliances 300 can be interconnected in full or partial mesh networks to increase the storage capacity and performance of the resulting cluster. Unlike conventional cluster implementations virtual devices can be spread across appliances by redirecting some messages across appliance interconnections.

A simplified version of the SCSI protocol illustrates basic operation of the technology. This protocol is referred to as the Simple Storage Protocol (SSP). SSP has two commands and two responses for purposes of illustration:

SSP Write command. Abbreviated SSPW. The SSPW message contains the address of a storage client, the address of a virtual device, the block number to be written and the data to be written

SSP Write response, abbreviated SSPWR. The SSPWR message contains the address of the storage client, the virtual device address from the associated SSPW and the status of the write operation (OK or FAILED)

SSP Read command, Abbreviated SSPR. The SSPR message contains the address of the storage client, the address of a virtual device, the block number to be read

SSP Read response, abbreviated SSPRR. The SSPRR message contains the address of the storage client, the address of a virtual device, the block number read, the status of the write operation (OK or FAILED), and the data if the operation succeeded.

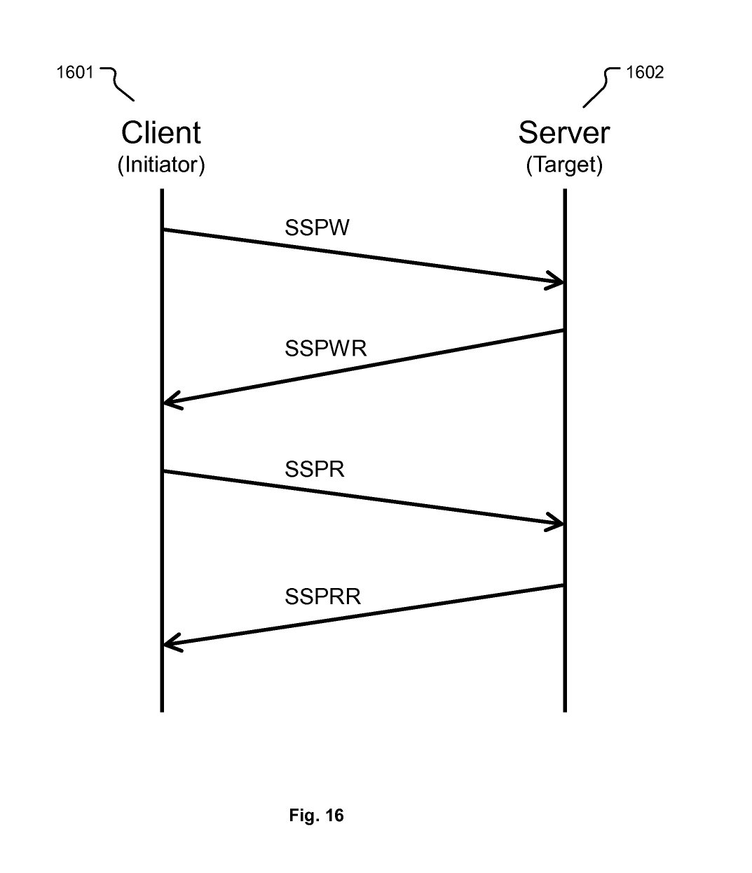

FIG. 16 illustrates SSP write and read transactions with client 1601 and server 1602.

The storage appliances in FIG. 1 provide a number of storage appliance features as follows.

Implementations for SCSI Based Protocols

Many of the storage protocols currently in use are based on the SCSI standard including Fibre Channel, Fibre Channel over Ethernet, iSCSI, iSER, IFCP and FCIP. In these protocols the read/write operations are divided in to a command phase and data transfer phase. The command phase read and write messages contain a virtual block address know as a Logical Block Address (LBA). The data transfer phase messages do not contain the virtual block address; instead they contain a relative offset to the LBA from the command phase. The apparatus for storage virtualization, RAID0 and RAID5 require a LBA absolute value that the switch can use for packet redirection. Clients for SCSI derived protocols can be made to place the low order bits of an LBA absolute address in the relative offset field in the data transfer phase messages by a number of methods.

Block Size Spoofing

In one embodiment the block size of a virtual device reported to a storage client via the response to a SCSI Inquiry command is selected such that the offset in the data phase packets is the low order portion of an LBA absolute address. These blocks are “stripe aligned” in RAID terminology.

RAID Aware File Systems

File systems including the ext3 and ext4 file systems from Linux are “RAID aware” and will perform stripe aligned accesses. This can be used as an alternative to block size spoofing previously described.

Storage Virtualization

Storage virtualization is the presentation of physical storage to storage clients as virtual devices. The physical storage that corresponds to a virtual device can come from one or more physical devices and be located anywhere in the physical address space of the physical devices. Storage virtualization therefore requires translation between virtual devices and virtual addresses and physical devices and physical device addresses.

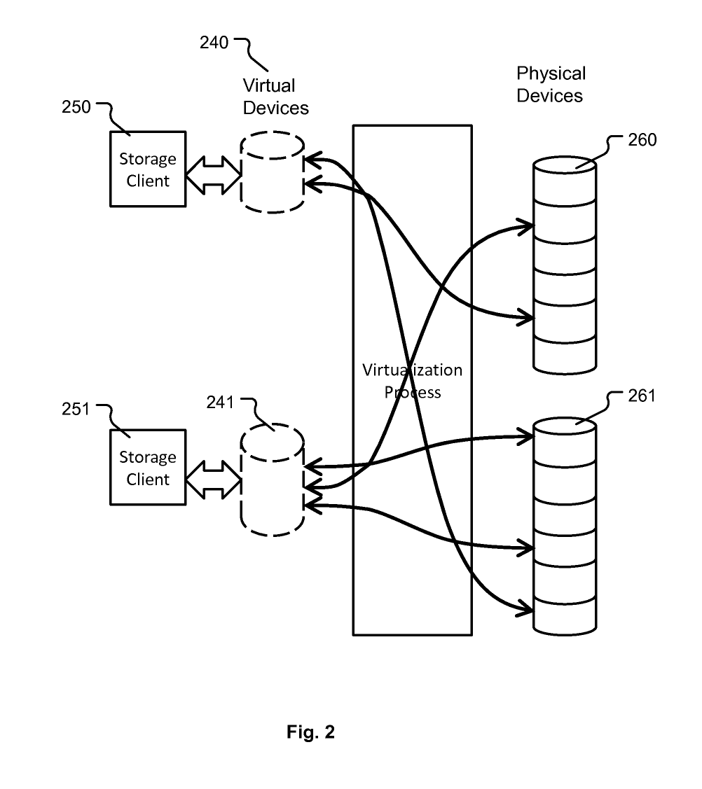

FIG. 2 illustrates the mapping between virtual devices 240 and 241 presented to a pair of storage clients 250 and 251 and the corresponding storage space on a pair of physical devices 260 and 261. The virtualization process makes the storage space on the physical devices appear to the storage client as though it were a single device with a contiguous address space.

Conventionally a CPU is responsible for making the decision of which physical device contains a chunk of data belonging to a virtual device and sending write data or requesting read data from that device. In some embodiments both the decision making and data transfer functions are implemented by the switch. The decision making component looks at fields in the storage protocol being used (such as the relative offset field in a SCSI command inside a Fibre channel frame encapsulated in an FCoE frame).

In one embodiment storage virtualization is implemented as a two step process:

i) Redirection of data to one or more target devices

ii) Virtual to physical address translation.

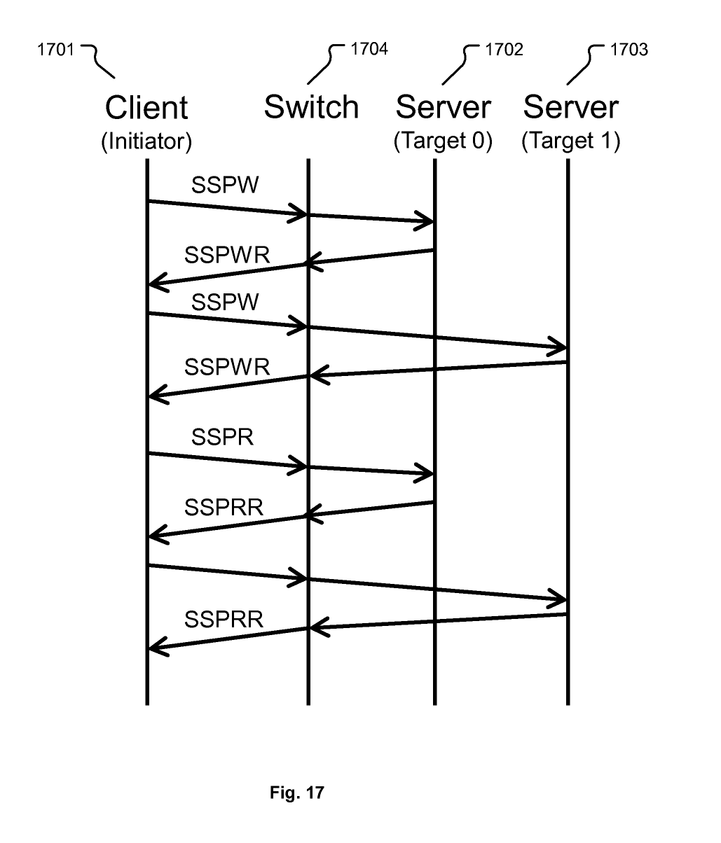

FIG. 17 illustrates the use of the switching component for virtualization with two targets 1702 and 1703. The messages sent by the client 1701 are identical to those in FIG. 16. The switch 1704 uses the block number in the commands to determine which target should receive each command and re-directing them to the appropriate target. The re-direction can be implemented in a number of ways including but not limited to modifying the message headers, encapsulating the messages in another protocol such as a VLAN stack or simply modifying the forwarding decision within the switch without altering the message.

Virtualization can be extended to any number of targets subject to the limitations of the switching components such as forwarding table sizes.

Data Protection

Storage appliances typically provide one or more forms of data protection, the ability to store data without error in the event of component failures within the storage appliance e.g. storage device or computer system failures. Computer system failures are dealt with by duplicating computer system components such as RAID controllers, power supplies and the computer itself. Device failures are addressed by RAID.

For RAID1 a CPU is conventionally responsible for sending write data to two different storage devices. In some embodiments this replication (A.K.A. a data copy) uses the switch. For RAID0 the CPU decides how to stripe the data across multiple devices and sends the data to the selected devices. In some embodiments the switch makes the decision based on fields in the storage protocol and does the data transfer w/o CPU involvement. RAID10 is a combination of these two techniques. RAID5 is the technique used in RAID0 plus parity calculations distributed across the storage targets.

RAID—the acronym RAID (Redundant Array of Independent Disks) was originally applied to arrays of physical devices. Various data protection schemes for data protection have been developed. These various mechanisms are described as RAID levels. RAID levels are typically written as RAIDx where x is one or more decimal digits.

RAID0 is also known as striping. In RAID0 sequential data blocks are written to different devices. RAID0 does not provide data protection but does increase throughput since multiple devices can be accessed in parallel when multi-block accesses are used.

RAID1 is also known as mirroring. In RAID1 data is written to two devices so that if a single device fails data can be recovered from the other device.

In RAID5 data blocks are distributed across N devices (as in RAID1) and the byte wise parity of each “stripe” of blocks is written to an additional device. With RAID5 any failure of the N+1 devices in the “RAID set” can be repaired by reconstruction the data from the remaining functional devices.

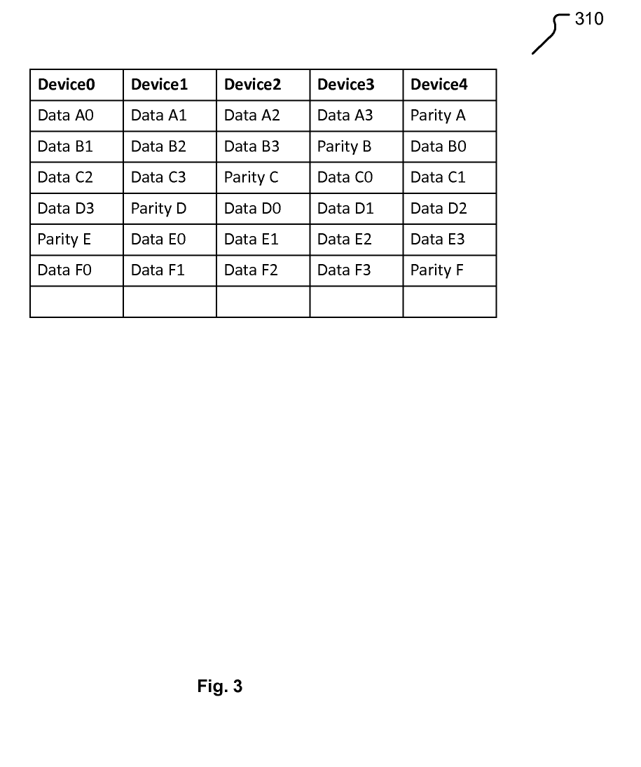

FIG. 3 illustrates one popular RAID5 data layout 310 for a 5 device RAID set. Each RAID stripe comprises four data blocks and a parity block. In this layout the parity blocks are distributes across the devices in the raid set.

Other RAID Levels

Conventional RAID nomenclature includes several other varieties of RAID:

RAID6—any RAID implementation that provides additional error correction coding to support reconstruction after multiple device failures. This includes diagonal parity.

RAID10, RAID50 and RAID60—These are combinations of multiple RAID levels e.g. RAID10 is mirrored sets of striped drives.

Parity De-Clustered RAID

Parity de-clustered raid uses a RAID5 or RAID6 array of logical volumes spread across a larger set of physical volumes. The blocks in a logical stripe are placed on different physical devices so that if a single physical device fails data/parity blocks from the failed device can be reconstructed. The primary benefit of parity de-clustered raid is that device reconstruction becomes a parallel process with the data accesses spread across a large number of devices.

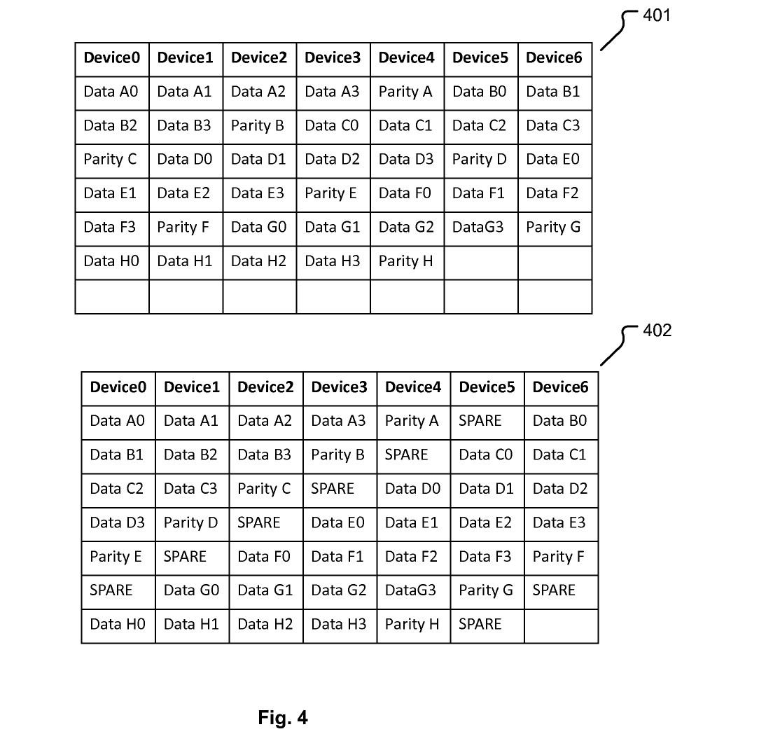

FIG. 4 illustrates a basic parity de-clustered RAID data layout 401 that spreads 4 data blocks and a parity block from 5 logical volumes across 7 physical devices and an alternative data layout 402 that includes spare blocks for device reconstruction. In the second example spare blocks can be used in reconstruction in parallel resulting in decreased device reconstruction times.

For parity de-clustered RAID some embodiments takes advantage of the large forwarding tables in modern Ethernet switches and use multiple mappings of logical block addresses (in the storage protocol) to direct the read and write data transfer operations to a large number of targets. Such embodiments provide some decision making and lots of data movement usually provided by the CPU in a storage appliance.

Virtual Device RAID

While RAID was traditionally used to describe the use of multiple physical devices to increase performance and provide data protection RAID terminology has been adopted for the description of data protection features applied to virtual devices as well. Placement of blocks in the same RAID5 stripe is subject to the same restrictions as in parity de-clustered RAID.

The performance of all prior art data protection schemes previously described can be greatly improved by using the network switch to redirect and/or replicate packets containing write data, a function conventionally performed by the computer system in FIG. 1.

RAID0 (Striping)

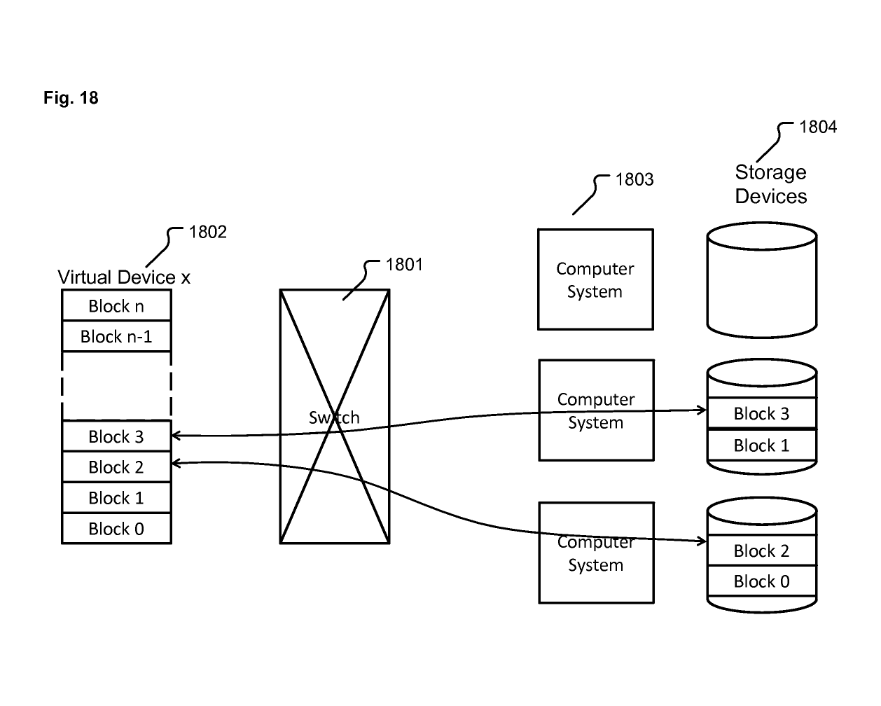

FIG. 18 shows the use of the network switch 1801 to increase the performance of RAID0. In this example, if the storage client is using a SCSI derived storage protocol to access a virtual device 1802, the storage client may be configured to use a RAID aware file system or the virtual device 1802 may report a block size that is a integer multiple of the stripe size. The network switch 1801 is configured to use the relative offset field in the data packets to determine where to send write data packets. The computer systems 1803 in FIG. 18 determine where on the storage devices 1804 to place the write data.

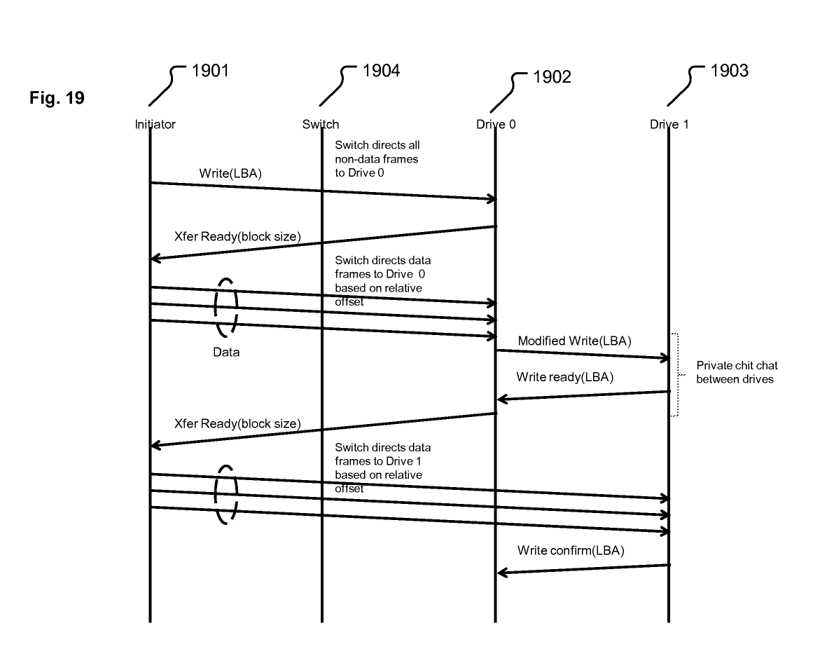

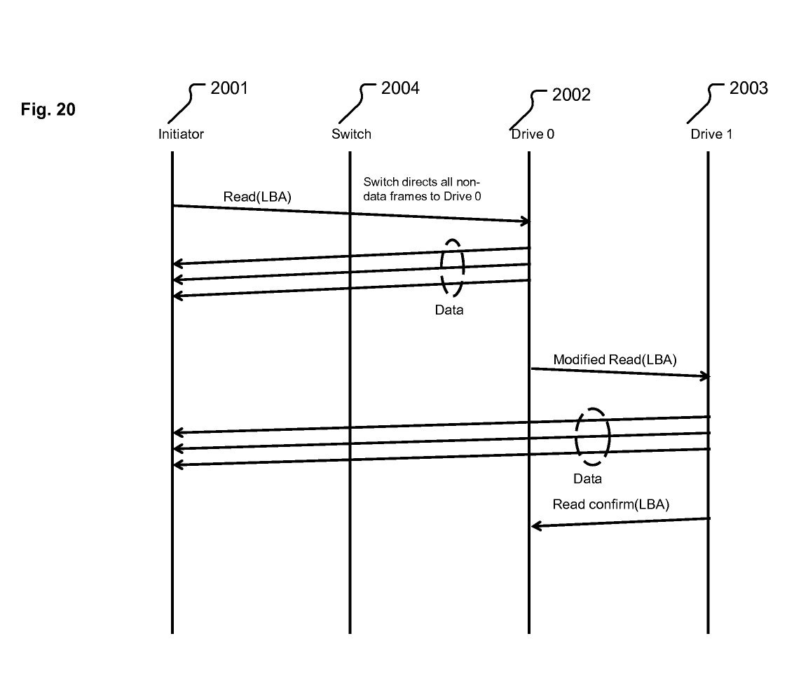

FIG. 19 shows a write operation for SCSI derived protocols, with initiator 1901, drive 0 1902, drive 1 1903, and switch 1904. FIG. 20 shows a read operation for SCSI derived protocols, with initiator 2001, drive 0 2002, drive 1 2003, and switch 2004.

RAID1 (Mirroring)

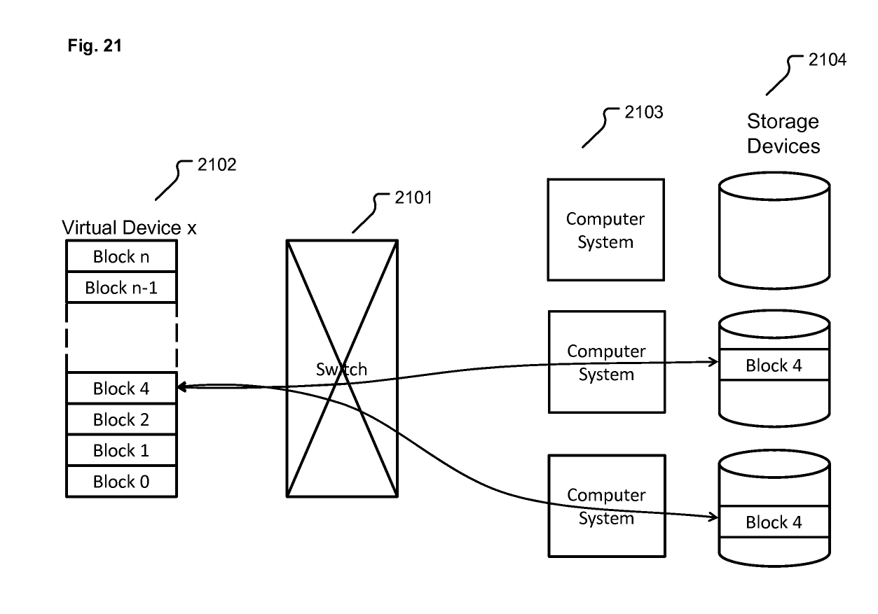

FIG. 21 shows RAID1 or mirroring with virtual device 2102, switch 2101, computer systems 2103, and storage devices 2104.

RAID5

Basic Operation

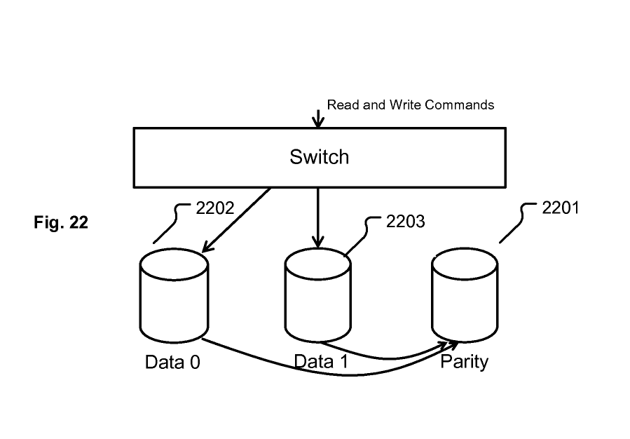

In one embodiment RAID5 is implemented by combining the data distribution of RAID0 in the embodiment previously described with a distributed incremental parity calculation. When a target virtual device receives a write data block the change in parity (incremental parity) is calculated by exclusive ORing the write data with the currently stored data. The results are sent to the virtual device that stores the parity (Parity Device 2201) in an incremental parity message as shown in FIG. 22.

The parity device exclusive OR's the incremental parity updates with the corresponding parity block to produce a new parity block. Parity checking on read is performed by sending the current block data in an incremental parity message to the parity device. The contents of the incremental parity messages are exclusive ORed together and the result compared with the stored parity. If the parity does not match then an error has occurred. Which block is in error can be determined from the error correction code used by the devices.

FIG. 22 illustrates a three virtual device RAID set with parity device 2201 and storage drives 2202 and 2203. In practice any number of data devices can be used.

Interaction with RAID Aware File Systems

In another embodiment a special “no parity change” form of the incremental parity message is used when the result of the exclusive OR operation is all zeros. As previously mentioned file systems including the ext3 and ext4 file systems from Linux are “RAID aware” and will perform stripe aligned accesses. This can be used to advantage in this embodiment. Small block random I/O will be implemented by these file systems as read modify write operations on full stripes where most of the data blocks in a stripe do not change. The virtual devices that contain data that didn't change on a write can send a no parity change message and acknowledge the write without writing data to their device(s). For random I/O with large RAID sets this results in many no parity change messages and writes only to devices with modified data and the parity device.

Data Placement for SSD Based Systems

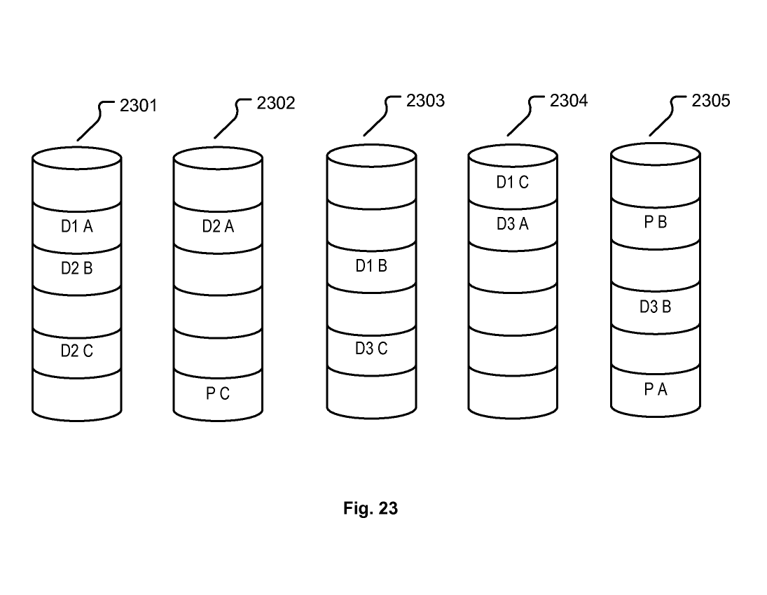

In these embodiments virtual devices can be mapped to multiple physical devices. FIG. 23 illustrates such a mapping. In this example a RAID set with three data devices, D1, D2 and D3 and a parity device P have been divided in to three components A, B and C and distributed across 5 physical devices 2301-2305. Since the parity blocks are updated more frequently they can be distributed across multiple SSDs to minimize the impact of write amplification.

Distributed Parity Calculations

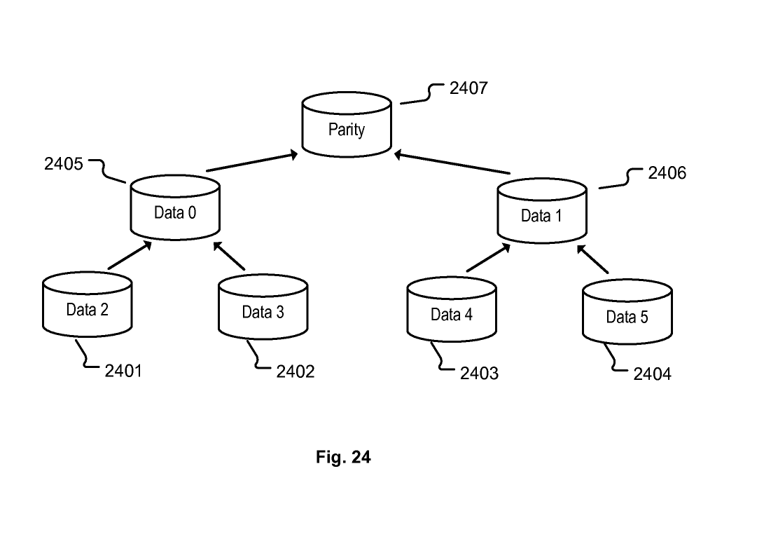

In another embodiment the parity calculations are distributed among the data devices 2401-2406 and the parity device 2407. FIG. 24 illustrates one such embodiment where data devices and the parity are organized in a hierarchy. Data devices in the lower levels of the hierarchy 2401-2404 send their incremental parity update messages to data devices in the next higher level in the hierarchy 2405-2406, and then the parity device 2407.

Thin Provisioning

Thin provisioning is the process of allocating physical storage to a virtual device on an as needed basis. Physical storage can be allocated when a write occurs. Optionally some physical storage can be pre-allocated so write operations are not delayed by the allocation process. Thin provisioning is most advantageous when virtual devices are sparsely written i.e. many virtual blocks are not used for storage.

Thin provisioning uses the storage of data that identifies which virtual addresses are associated with data and where that data is stored in addition to the data itself (metadata).

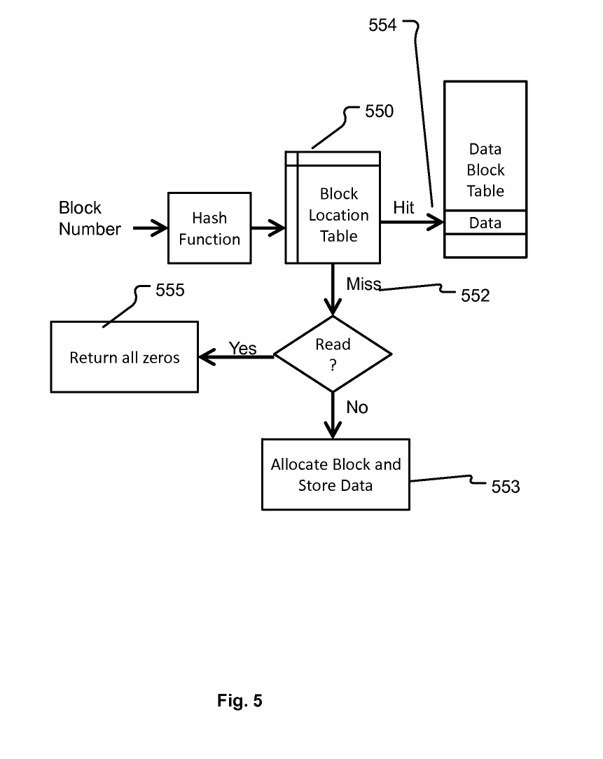

FIG. 5 illustrates one implementation of thin provisioning. In this implementation a hash table (block location table 550) is used to determine if a block address has been written to and if so where the associated data is located. The first time a block address is written to the lookup in the hash table results in a miss 552. When this occurs a block in the data table is allocated and the data is written to it 553. Additional writes to the same block address will update the previously allocated entry 554. When a read occurs the hash table is used to locate where the data block is stored and the data is returned to the reader. In the implementation shown reading a block that has not previously been written returns all zeros 555.

The size of the data table can be reduced if the client implements a de-allocation command such as the SATA TRIM command. When a TRIM command for a block address is received the data table and hash table entries for that address can be reclaimed.

In one embodiment thin provisioning is implemented as a distributed process by the computer systems after the switch has performed the redirection portion of the storage virtualization or data protection operations. The hash table, data table and processing described in connection with FIG. 5 are distributed across multiple physical devices.

De-Duplication

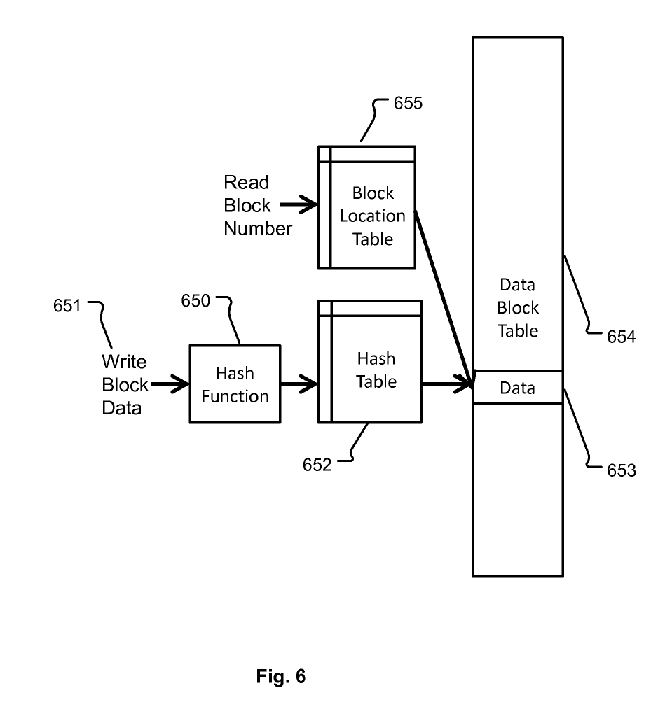

Many applications store multiple versions of the same file or largely similar files. This duplication can result in a large number of blocks on a block storage device containing identical data. De-duplication is the process of eliminating these redundant blocks. De-duplication systems typically use hash functions to reduce the work of detecting duplicated blocks. FIG. 6 illustrates a simplified version of such a hash based de-duplication system.

When a block of data is to be written a hash function 650 of the data to be written 651 is calculated. The output of this hash function 650 is used as the index to a hash table 652. If another block with the same data contents has previously been written then the indexed entry in the hash table will point to the stored data block 653 and the data blocks should be compared to determine if the data is identical. For this simplified example we will assume that the data blocks are identical and ignore the various methods of dealing with hash collisions. If there is not a hash table entry and stored data block then these will be created. In either case the block location table will be updated with the location of the data block 653 in the data block table 654.

When a block of data is read the location of the block in the data block table is looked up in the block location table 655 and then the data is read from the block data table 654.

De-duplication saves space in the data block table (typically disk) by only storing one copy of any set of identical blocks. When a data block is deleted or written to a different value additional housekeeping is performed. Before a block can be deleted or altered a check is performed to determine if other entries in the block location table reference the data block table entry. Practical de-duplication uses reference counters or back pointers to speed up this process.

Regarding thin provisioning and de-duplication, in some embodiments the clients perform a function conventionally performed by the CPU in the storage appliance e.g. generating hash values used in the traditional implementations and placing these hash values in the storage packets (not done in conventional implementations). This lets the switch redirect (data movement) the packets to the correct target. This can be combined with another data movement operation e.g., copying data and sending a second packet (or third, fourth . . . ) to another storage device.

De-duplication can be implemented in this technology either as a distributed process similar to the implementation of provisioning that distributes the processing and metadata across multiple physical devices or with the use of smart clients that perform the hashing function used in de-duplication or by distributing data requiring hashing to a plurality of compute resources that provide the hashing function computation.

In one embodiment storage clients include the output of a hashing function applied to the data in read and write commands. In this embodiment the switches use a portion of this hash field to redirect read and write commands to one of a plurality of storage targets. The storage target then uses the rest of the hash field for conventional de-duplication.

In another embodiment the read and write commands are redirected to a subset of the plurality of storage targets such that data can be replicated as well as de-duplicated.

In another embodiment write data is distributed to a plurality of computer systems (301) that perform the hashing function and retransmit the write data with the output of the hashing function added to the write data message. In this embodiment the switches use a portion of this hash field to redirect read and write commands to one of a plurality of storage targets. The storage target then uses the rest of the hash field for conventional de-duplication.

Snapshots

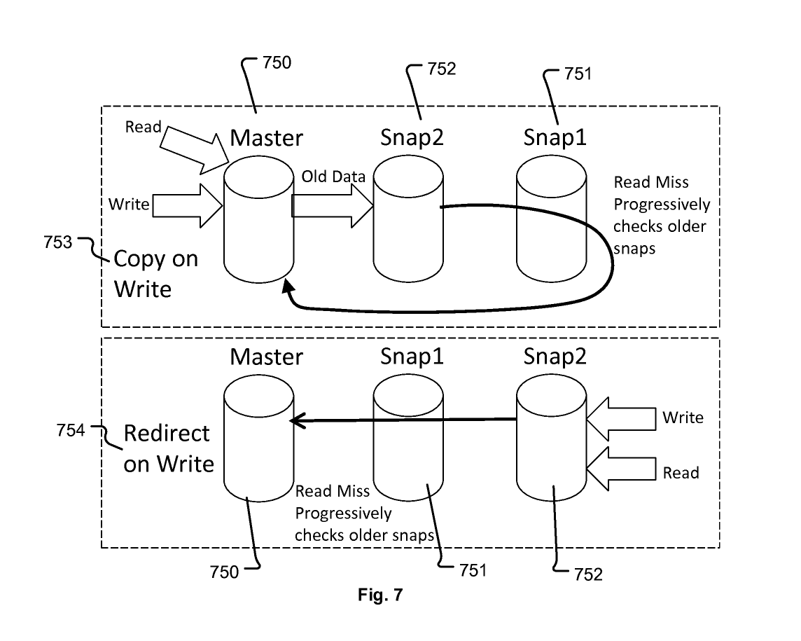

A snapshot of a storage device is a point in time copy of the device. Snapshots are useful for functions such as check pointing and backup operations. Snapshots are frequently described in terms of a master, the original data before a snapshot is created and one or more “snaps” that represent the data at a specific point in time. FIG. 7 illustrates two common implementations for snapshots. These examples show an original or master volume 750 and two consecutive snapshots Snap1 751 and Snap2 752. Snap1 751 is the older of the two snapshots. Copy on write 753, as the name implies, copies data from the master to a snap when a write occurs (after the snapshot time).

Redirect on write 754 redirects write commands to a new volume after a snapshot occurs.

Snapshots can be implemented as a Copy On Write (COW) or Redirect On Write (ROW), in either case with a data movement component i.e. redirection of copying involved performed with the switch. Cloning is essentially an application of snapshots.

Cloning is the process of creating multiple identical copies based on a single virtual device. Cloned virtual devices are commonly used for Virtual Desktop

Infrastructure and as the storage devices for virtual machines.

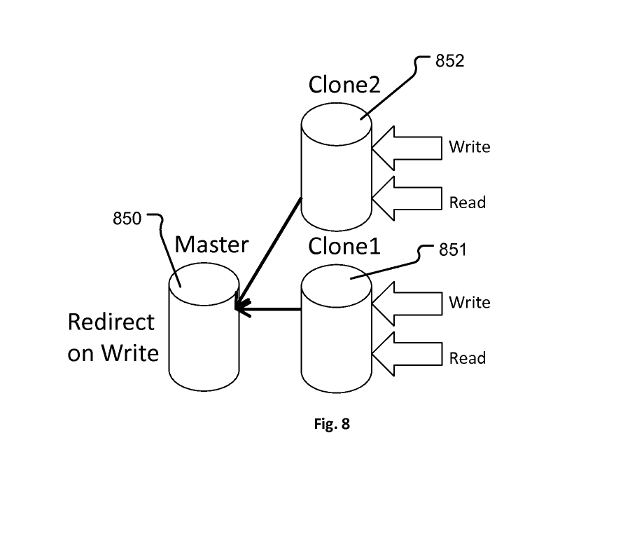

FIG. 8 illustrates the implementation of clones using multiple snapshot chains. In this implementation a master 850 such as a basic operating system installation is created. Multiple snapshots 851 and 852 are then used to create clones that share the same read only master i.e. all data that makes the clones unique is stored in the snapshot chains.

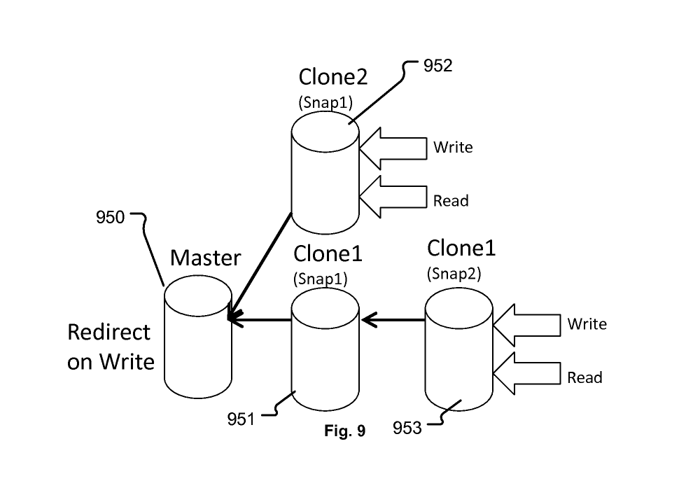

One advantage of this type of cloning is that it is possible to make snapshots of clones. This simplifies the process of check pointing clones and backing up clones. FIG. 9 illustrates an implementation of snapshots of clones.

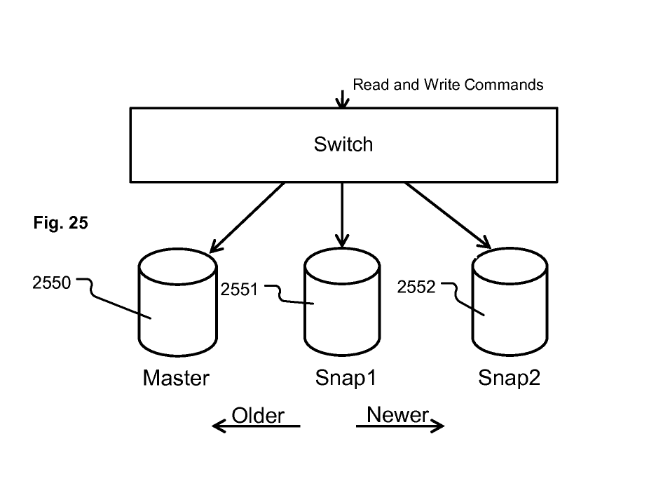

FIG. 25 illustrates one embodiment of snapshots. A virtual device with snapshots is a collection of virtual devices. The master 2550 is the original or oldest virtual device. Snapshots 2551 and 2552 are additional virtual devices. In this embodiment redirect on write snapshots in implemented using the switching component to direct write commands to the virtual device containing the latest snapshot. Read commands can be directed to the latest snapshot or multicast to all of the virtual devices containing snapshots and the master virtual device.

In this embodiment the snapshots are implemented as thinly provisioned virtual devices to minimize the storage required for snapshots. A new snapshot is created by provisioning a new virtual device for the snapshot and updating the switch configuration to redirect read and write commands to the new virtual device. The set of snap shots are referred to as a snap shot chain or set.

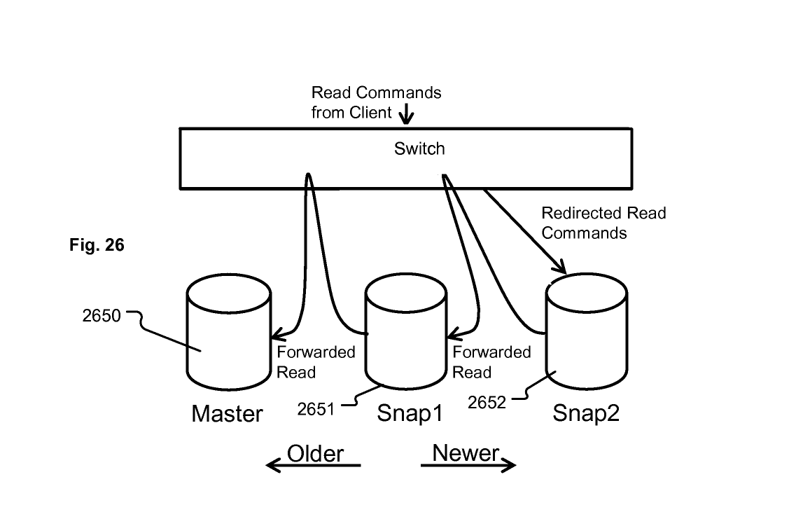

FIG. 26 illustrates the implementation of unicast reads in this embodiment. The client sends a read to the virtual device with snapshots. The switch redirects this read to the virtual device 2652 with the latest snapshot, rather than the master 2650 or an earlier snapshot 2651.

In this embodiment the latest snapshot 2652 is responsible for all write commands. Read commands are processed as follows:

The latest snapshot receives a read command.

If the latest snapshot contains data for the read it provides the data for the read operation.

Else the read command is passed to the next older virtual device (snapshot or master).

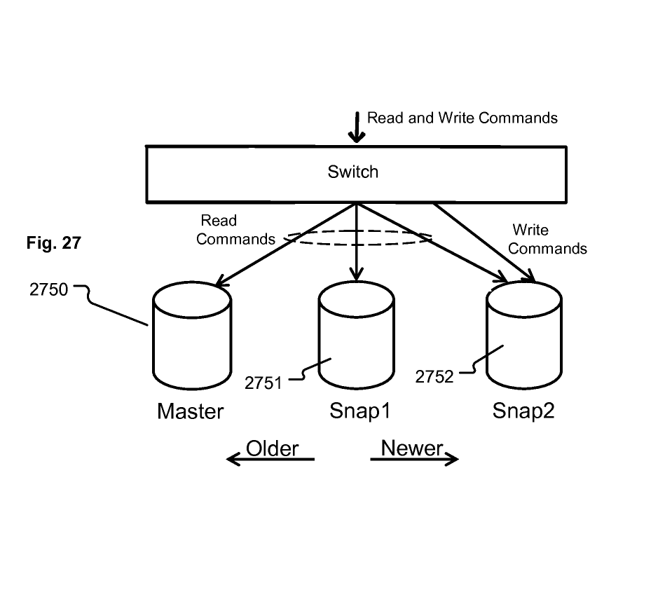

FIG. 27 illustrates another embodiment for a multicast read operation for a virtual device with two snapshots. The switch receives a read command from a client. This read command is multicast to the master 2750 and all snapshots 2751 and 2752 of the virtual device.

The master 2750 and all but the latest snapshot (2751 but not 2752) send a read inform message indicating the presence and or absence of data for the read. The latest snapshot determines which virtual device(s) will respond to the read and sends read confirm messages to the virtual device(s) indicating which blocks they should return to the client. The virtual devices send data to the client based on these messages.

Read commands can typically define a range of block addresses that are to be read (SCSI starting LBA and length). For example a SCSI read could specify a read of 8 blocks starting with Logical Block Address (LBA) 1024. The snapshots can contain subsets of the data needed for the read command. For example block 1026 could have been written after snap1 was created and block 1030 written after snap2 was created. In such a case the latest snap will determine which virtual device will supply which data blocks. For this example the master will provide blocks 1024, 1025, 1027, 1028, 1029, 1031 snap1 will provide block 1026 and snap2 will provide block 1030. In some embodiments the read results messages contain a bitmap that indicates which blocks in the requested range are stored in a particular virtual device. The latest snap uses a series of logical operations on these bitmaps to determine where the latest version of each block is located and generates the expected read confirm message(s) from this information.

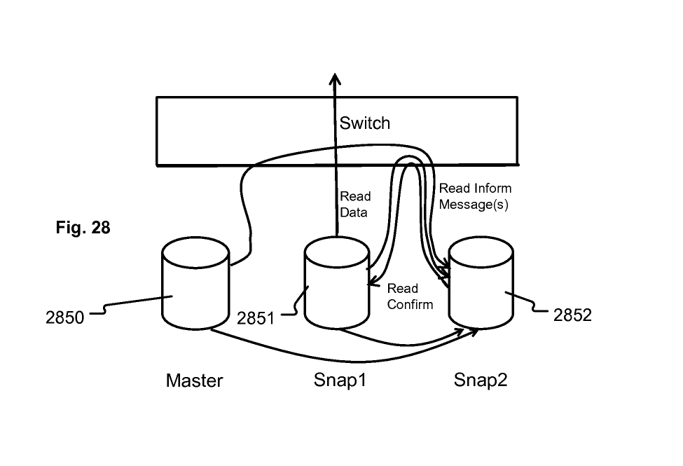

FIG. 28 illustrates another embodiment for resolving the results of a multicast read operation for a virtual device with a master 2850 and two snapshots 2851 and 2852.

One advantage of this implementation is that lost read commands or read inform messages can be detected as follows:

If the latest snapshot 2852 receives read confirm messages without receiving the associated read command the multicast read between the switch and the latest snapshot. In this embodiment the read confirm messages contain enough information for the latest to determine what the lost read command was and recover from the lost command.

If one of the read inform messages is lost the latest snapshot 2852 can detect this using a read inform timer. If the timer expires without all the read inform messages being received the latest snapshot 2852 forwards a copy of the read command to the virtual device that did not provide a read inform message.

A second advantage of this implementation is that performance of the virtual device with snapshots is improved through the parallelization of the lookup process that determines which virtual device contains the data requested by the client.

Object Storage

Object storage systems store data in key value pairs. Keys can be any identifier that uniquely identifies an object. Data can be a variable or fixed size block of associated data. Hashing is frequently used as the mechanism to map keys to stored objects. Consistent hashing and extensible hashing have been used for distributed object stores.

Object stores are commonly implemented as distributed systems. The objects are distributed across multiple “nodes”. Distributed object stores divide the object database into shards that are handled by different nodes. A node can be a single computer system, a process or virtual machine.

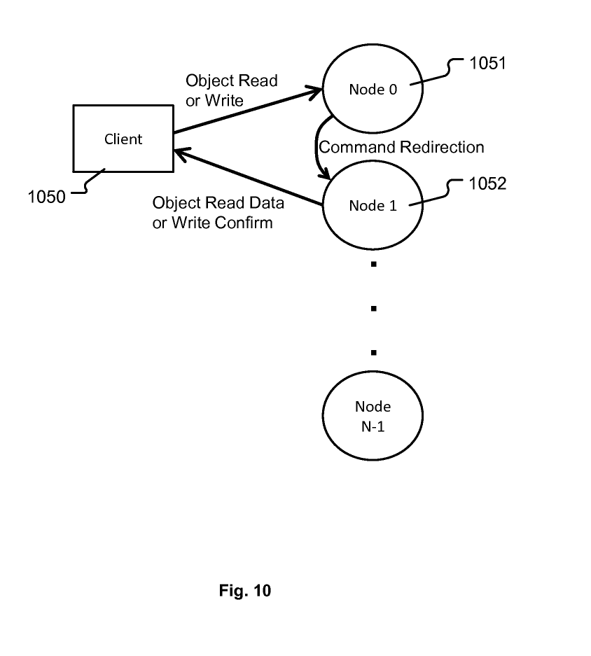

FIG. 10 illustrates a simple object storage cluster. In this example clients such as 1050 direct all their access queries to a single node such as Node 0 1051. If the object being accesses is not on the node the client directed its access to then that node redirects the access to a node such as Node 1 1052 where the data can be found.

Some object storage systems e.g. ceph, use “smart clients” that have some potentially imperfect information about which node holds which objects. In these systems the object query is directed to a node that, according to the information the client has, has the desired object.

For object storage, some embodiments are also deal with copying (replication) and redirection based on data in the storage packets. As in thin provisioning and de-duplication some embodiments have the clients place hash values in the packet. One difference is that in object stores the clients conventionally perform the hash function to figure out which node to send data to. In some embodiments the clients include the hash in the storage packets, which simplifies the job of the client since that don't need to manage multiple connections to the storage targets. The switch gets the data to the right storage device. In a conventional object store the storage devices are responsible for replicating (copying) data to other storage devices. In some embodiments the “multicasting” capability of the switch offloads the replication function as well.

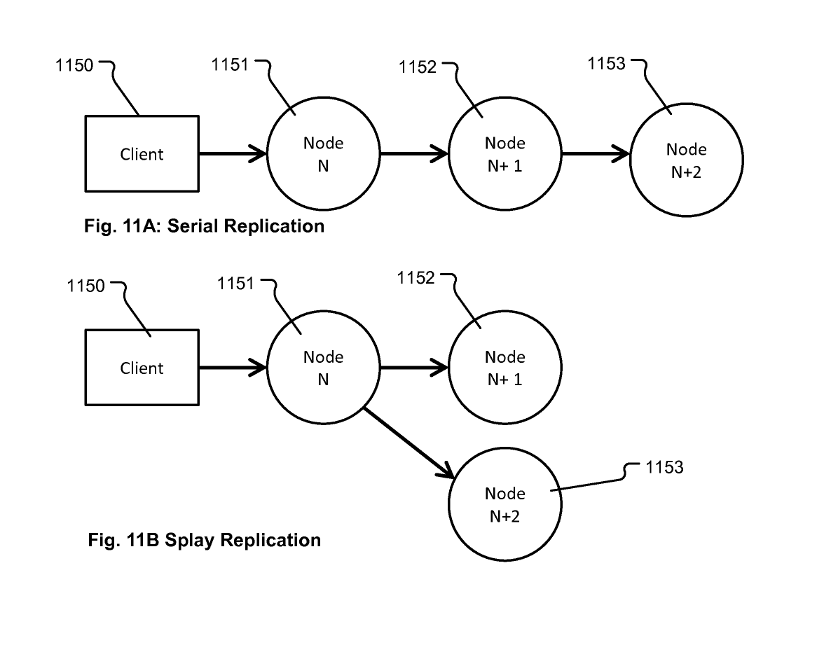

Practical object stores are designed to provide protection from node failure and storage device failures. This is commonly done by replicating data across multiple nodes (and thereby multiple storage devices). FIGS. 11A and 11B illustrates two of the commonly used data replication schemes used in object stores.

One of the simplest replication mechanisms is serial replication shown in FIG. 11A. In this example node N 1151 receives all commands associated with a range of hash values from client 1150.

When an object is created or updated (object writes) the command is forwarded on to the next M-1 nodes so that there are M copies of every object.

FIG. 11B illustrates “splay replication” which forwards the commands to multiple nodes in parallel such as Node N+1 1152 and Node N+2 1153.

Object stores with replication frequently incorporate some mechanism to determine when the write commands have been successfully processed.

Object stores frequently use consistent hashing to distribute objects to the nodes in a cluster. As previously noted hashing is frequently used to reduce variable length keys to a fixed size hash function output. Examples of such hash functions are CRC function and cryptographic functions such as Hashing Message Authentication Code, Advanced Encryption Standard, 256 bit (HMAC AES256).

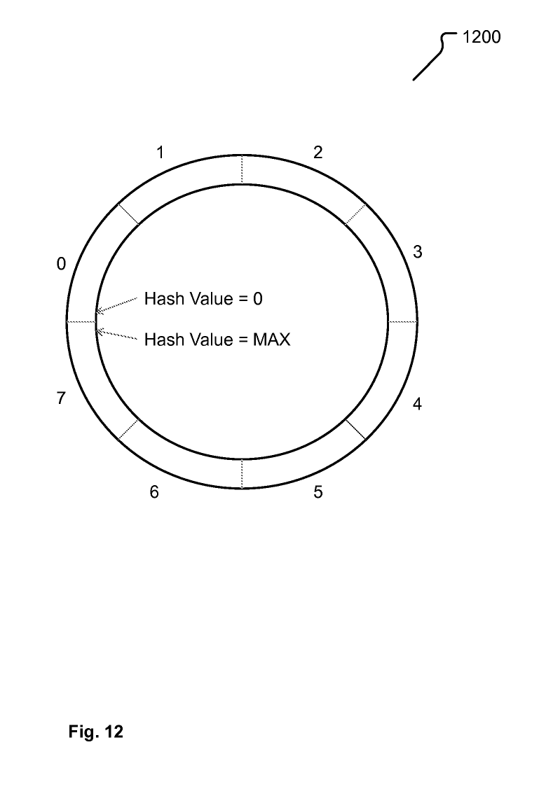

Such functions are used in consistent hashing for object stores. Texts on object stores conventionally represent the range of hash values as a ring 1200 as shown in FIG. 12. The output of the hash function can be thought of as an address used to access an hash address space of hash space or as an index into a hash table. Systems using consistent hashing divide the hash space into a large number of segments. These segments are assigned to the devices in a cluster such that the data corresponding to different segments is sent to different nodes. The techniques developed in this technology for storage virtualization, data protection, thin provisioning, de-duplication and snapshots can also be applied to distributed applications such as object storage systems. For example a hash value included in a storage message can be used to determine which node the switch sends a storage message to and which other nodes it sends duplicates of the message to. The switch can also mark the messages as primary, first copy, second copy and so forth.

The techniques developed in this technology for storage virtualization, data protection, thin provisioning, de-duplication and snapshots can also be applied to distributed applications such as object storage systems. These object storage systems include NoSQL databases such as Cassandra, riak and MongoDB, the ceph file system and any other application that spreads data across multiple servers using similar mechanics.

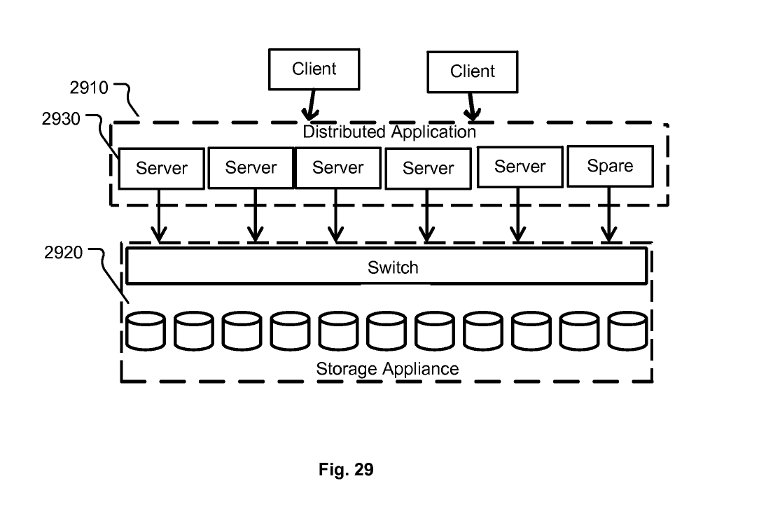

FIG. 29 illustrates the combination of a distributed application 2910 and a switch based storage appliance 2920. The back end storage functions of the distributed application are provided by the appliance. Many of these applications store all the data belonging to a virtual node or partition in a single directory. For these applications these directories can be implemented as a virtual device mounted at the location where the vnode or partitions directory would be found in the servers file system.

When a server 2930 fails in a distributed application the data belonging to the vnodes or partitions that were running on the failed server are recreated from the replicas stored by other vnodes or partitions on either another server of a spare server. Reconstruction involves copying data from replicas to a new location.

In one embodiment the data movement involved in reconstructing failed servers, vnodes or partitions is replaced by remapping a virtual device to another server where the vnode or partition can be restarted.

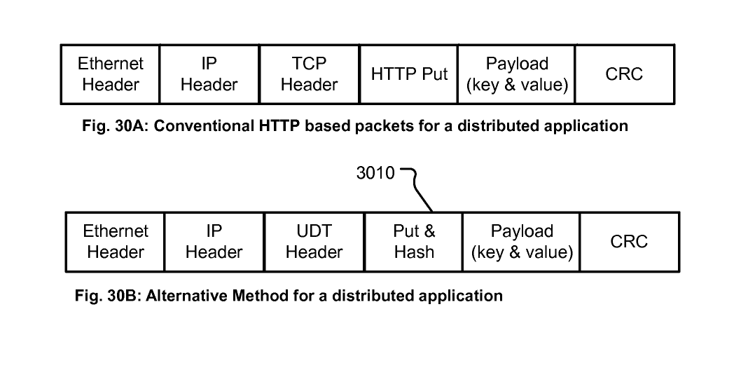

Many distributed applications use key value databases for storage. The clients for these applications are sometimes categorized as dumb clients which only communicate with a single application server and smart clients that communicate directly with all of the servers. FIG. 30A illustrated a typical message format for such a distributed application. In the case of dumb clients the distributed application servers forward the messages to the server that should process them creating extra load on the servers. In the case of smart clients the clients decide which server to send the messages to creating additional load on the clients and requiring that the clients maintain a current map of all the servers e.g. the CEPH cluster map. This decision is typically made based on a hash of the key. FIG. 30B illustrates an alternative method that reduces the load on the client compared to a smart client implementation without increasing the load on the servers. In this embodiment the clients are modified to calculate a hash based on the key and include this and the associated data base commands such as a put or get in the message such as 3010. Since the switches operate on data in fixed locations in the packets a protocol other than TCP should be used so that the location of the hash field is fixed. This can be accomplished using standard protocols such as UDT, SCTP or proprietary protocols. The switch can then make forwarding decisions based on the hash field is addition to the conventional fields.

In another embodiment the back end key value stores used by a distributed application are implemented by the storage appliance. In this embodiment write commands are multicast to the primary node and the secondary nodes responsible for the object. In this embodiment write confirmations from the secondary nodes can be coalesced by the primary node. The hash field shown in FIG. 30B can be used to determine which group of back end key value stores the packet is forwarded to. In another embodiment the back end key value stores used by a distributed application are implemented by the storage appliance. In this embodiment read commands are multicast to the primary node and secondary nodes responsible for the object. In this embodiment object time stamps can be verified by the primary node and a single response returned to the client by the primary node. In an alternative embodiment all of the responses can be returned from the primary and secondary nodes to the client.

In another embodiment the switches add a high accuracy time stamp to all packets that ingress the switch from clients. This time stamp is used in conjunction with or as an alternate for the time stamp used in NoSQL databases such as RIAK to control writes sequencing and resolve data conflicts between primary and secondary nodes.

Combining Embodiments

One skilled in the art will recognize that these embodiments can be combined in a variety of ways to implement storage features. One example of such a combined embodiment is the use of a RAID volume for the master in a snapshot. Another example is the use of a single read only master and a plurality of snap shot chains to represent a plurality of “clones” of the original master where the snap shot chains contain the data that differentiates the clones.

Although the present invention has been described in detail with reference to one or more embodiments, persons possessing ordinary skill in the art to which this invention pertains will appreciate that various modifications and enhancements may be made without departing from the spirit and scope of the Claims that follow.

The various alternatives for providing storage virtualization, data protection de-duplication snapshots and object storage that have been disclosed above are intended to educate the reader about embodiments of the invention, and are not intended to constrain the limits of the invention or the scope of Claims.

We claim:

1. An apparatus, comprising:
a storage appliance including:
a plurality of storage communication ports coupleable to different ones of a plurality of storage devices;
memory supporting a plurality of forwarding tables, different ones of the plurality of forwarding tables associating at least one of a same data link layer address and a same network layer address to different ones of the plurality of storage communication ports;
switch circuitry configured to forward, at at least one of a data link layer and a network layer, packets compliant with a storage protocol, to identified ones of the plurality of storage communication ports; and
control circuitry configured to support a plurality of storage commands of the storage protocol including at least a write storage command that writes to the plurality of storage devices and a read storage command that reads from the plurality of storage devices, the control circuitry supporting a plurality of packet fields of packets compliant with the storage protocol, the plurality of packet fields including at least a first packet field of the storage protocol for at least one of a data link layer address and a network layer address that identifies one of the plurality of storage communication ports via one of the plurality of forwarding tables in the memory, and a second packet field of the storage protocol identifying said one of the plurality of forwarding tables.

2. The apparatus of claim 1,
wherein the write storage command and the read storage command identify a storage block number.

3. The apparatus of claim 1,
wherein the apparatus implements storage appliance operations by division of the storage appliance operations into (i) data movement operations performed by the switch circuitry instead of the general processor circuitry and (ii) general computation operations performed by the switch circuitry instead of the general processor circuitry.

4. The apparatus of claim 1,
wherein the storage appliance operations include storage virtualization.

5. The apparatus of claim 1,
wherein the storage appliance operations include data protection.

6. The apparatus of claim 1,
wherein the storage appliance operations include parity de-clustered RAID.

7. The apparatus of claim 1,
wherein the storage appliance operations include thin provisioning.

8. The apparatus of claim 1,
wherein the storage appliance operations include de-duplication.

9. The apparatus of claim 1,
wherein the storage appliance operations include snapshots.

10. The apparatus of claim 1,
wherein the storage appliance operations include object storage.

11. An apparatus, comprising:
a storage appliance including control circuitry configured to support a plurality of storage commands of a storage protocol including at least a write storage command that writes to a plurality of storage devices and a read storage command that reads from the plurality of storage devices, including:
a plurality of storage communication ports coupleable to different ones of a plurality of storage devices;
memory supporting a forwarding table, the forwarding table associating at least one of a data link layer address and a network layer address to one of a plurality of storage communication ports;
switch circuitry configured to forward, at at least one of a data link layer and a network layer, packets compliant with a storage protocol, to identified ones of the plurality of storage communication ports; and
general processor circuitry,
wherein the apparatus implements storage appliance operations by division of the storage appliance operations into (i) data movement operations performed by the switch circuitry instead of the general processor circuitry and (ii) general computation operations performed by the switch circuitry instead of the general processor circuitry.

12. The apparatus of claim 11,
wherein the storage appliance operations include storage virtualization.

13. The apparatus of claim 11,
wherein the storage appliance operations include data protection.

14. The apparatus of claim 11,
wherein the storage appliance operations include parity de-clustered RAID.

15. The apparatus of claim 11,
wherein the storage appliance operations include thin provisioning.

16. The apparatus of claim 11,
wherein the storage appliance operations include de-duplication.

17. The apparatus of claim 11,
wherein the storage appliance operations include snapshots.

18. The apparatus of claim 11,
wherein the storage appliance operations include object storage.

19. The apparatus of claim 11,
wherein the write storage command and the read storage command identify a storage block number.

20. The apparatus of claim 11,
wherein the memory supports a plurality of forwarding tables, different ones of the plurality of forwarding tables associating at least one of a same data link layer address and a same network layer address to different ones of the plurality of storage communication ports; and
wherein the control circuitry supports at least a plurality of packet fields of packets compliant with the storage protocol, the plurality of packet fields including at least a first packet field of the storage protocol for at least one of a data link layer address and a network layer address that identifies one of the plurality of storage communication ports via one of the plurality of forwarding tables in the memory, and a second packet ii field of the storage protocol identifying said one of the plurality of forwarding tables.

21. A method of operating a storage appliance configured to support a plurality of storage commands of a storage protocol including at least a write storage command that writes to a plurality of storage devices and a read storage command that reads from the plurality of storage devices, and including a plurality of storage communication ports coupleable to different ones of a plurality of storage devices, comprising:
processing a plurality of packet fields of packets compliant with the storage protocol, the plurality of packet fields including at least a first packet field of the storage protocol for at least one of a data link layer address and a network layer address that identifies one of the plurality of storage communication ports via one of a plurality of forwarding tables in a memory of the storage appliance, and a second packet field of the storage protocol identifying said one of the plurality of forwarding tables, wherein different ones of the plurality of forwarding tables in the memory associate at least one of a same data link layer address and a same network layer address to different ones of the plurality of storage communication ports; and
forwarding, at at least one of a data link layer and a network layer, the packets compliant with the storage protocol, to identified ones of the plurality of storage communication ports.

22. A method of operating a storage appliance configured to support a plurality of storage commands of a storage protocol including at least a write storage command that writes to a plurality of storage devices and a read storage command that reads from the plurality of storage devices, and including a plurality of storage communication ports coupleable to different ones of a plurality of storage devices, comprising:
implementing storage appliance operations on the storage appliance by division of the storage appliance operations into (i) data movement operations performed by switch circuitry in the storage appliance instead of the general processor circuitry and (ii) general computation operations performed by the switch circuitry instead of general processor circuitry in the storage appliance, including:
forwarding, at at least one of a data link layer and a network layer, packets compliant with the storage protocol, to identified ones of the plurality of storage communication ports according to a forwarding table.
